(19) United States
(12) Patent Application Publication
(10) Pub. No.: US 2023/0363459 A1
(43) Pub. Date: Nov. 16, 2023

(54) AEROSOL PROVISION DEVICE

(71) Applicant: Nicoventures Trading Limited, LONDON (GB)

(72) Inventors: Jai TAANK, London (GB); Michael THOMAS, London (GB); Matthew HOLDEN, London (GB); Conor MCGRATH, London (GB)

(21) Appl. No.: 18/245,578

(22) PCT Filed: Sep. 15, 2021
(86) PCT No.: PCT/EP2021/075350

§ 371 Date: Mar. 16, 2023

(30) Foreign Application Priority Data
Sep. 16, 2020 (GB) 2014601.5

(51) Int. Cl. A24F 40/465; A24F 40/20; H05B 6/10; H05B 6/36

(52) U.S. Cl. CPC A24F 40/465; A24F 40/20; H05B 6/105; H05B 6/36

(57) ABSTRACT

An aerosol provision device is described. One such device comprises a first chassis and an aerosol generating assembly. The aerosol generating assembly includes a heater assembly for receiving an aerosol generating material. The heater assembly comprises a susceptor which is heatable by penetration with a varying magnetic field. The aerosol generating assembly also has a second chassis extending around the susceptor; and an inductor coil extending around the second chassis, wherein the inductor coil is configured to generate the varying magnetic field. The second chassis comprises a locating arrangement configured to locate the aerosol generating assembly on the first chassis.

### PRIORITY CLAIM

The present application is a National Phase entry of PCT Application No. PCT/EP2021/075350, filed Sep. 15, 2021, which claims priority from GB Application No. 2014601.5, filed Sep. 16, 2020, each of which hereby fully incorporated herein by reference.

### TECHNICAL FIELD

The present disclosure relates to an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device, comprising: a first chassis; and an aerosol generating assembly, the aerosol generating assembly comprising: a second chassis; a heater assembly configured to receive aerosol generating material, wherein the heater assembly comprises a susceptor which is heatable by penetration with a varying magnetic field; the second chassis extending around the susceptor; and an inductor coil extending around the second chassis, wherein the inductor coil is configured to generate the varying magnetic field; wherein the second chassis comprises a locating arrangement configured to locate the aerosol generating assembly on the first chassis.

Correspondingly, the first chassis may comprise a cooperating arrangement configured to cooperate with the locating arrangement to locate the aerosol generating assembly on the first chassis.

The locating arrangement (and the cooperating arrangement) may be configured to restrict movement, such as displacement and/or rotation, of the aerosol generating assembly relative to the first chassis.

The second chassis may be configured to enclose the heater assembly.

The second chassis may be configured to locate the heater assembly on the first chassis.

The second chassis may comprise a coil support configured to support the inductor coil.

The locating arrangement may comprise a locating feature at least proximal to one end of the second chassis.

The aerosol provision device may comprise an end support at one end of the heater assembly, wherein the end support is mounted with the second chassis.

The locating feature may locate the second chassis with the first chassis and the end support may support the aerosol provision device on the first chassis.

The locating feature may comprise an abutment, the first chassis may comprise a cooperating surface, and the abutment may abut the cooperating surface to locate the aerosol generating assembly on the first chassis.

The second chassis may have a longitudinal axis, and the abutment may locate against the cooperating surface in a radial direction.

The locating feature may restrict rotation of the second chassis relative to the first chassis.

The abutment may be such that the aerosol generating assembly is positioned in a unique position and/or orientation relative to the first chassis. The abutment may be such that movement of the aerosol generating assembly relative to the first chassis is restricted.

The locating feature may comprise a pair of abutting surfaces extending in the axial direction. The surfaces may be spaced apart in a direction perpendicular to the longitudinal axis. The surfaces may be substantially parallel to each other.

The first chassis may comprise a pair of arms extending in a first direction perpendicular to the longitudinal axis. The arms may be spaced apart in a second direction perpendicular to the longitudinal axis and perpendicular to the first direction. At least one surface of the pair of arms may be a cooperating surface.

The locating feature may comprise at least one protrusion.

The first chassis may comprise at least one socket, and the at least one protrusion may be received by the at least one socket to locate the aerosol generating assembly on the first chassis. Each of or each protrusion may be configured to engage a respective one of the or each socket.

The engagement may be such that the aerosol generating assembly is positioned in a unique position and/or orientation relative to the first chassis. The engagement may be such that movement of the aerosol generating assembly relative to the first chassis is restricted.

The second chassis may have a longitudinal axis. The longitudinal axis may be a central axis around which the second chassis extends. The at least one protrusion may extend in the axial direction (for example, parallel to the longitudinal axis).

The at least one protrusion may comprise at least two legs protruding from the one end of the second chassis in the axial direction. The legs may be spaced apart in a direction perpendicular to the longitudinal axis.

The second chassis may comprise a rim, and the at least one protrusion may extend from the rim.

The locating feature may be a first locating feature at least proximal to a first end of the second chassis, and the second chassis may comprise a second locating feature at least proximal to a second end of the second chassis.

The second locating feature may have the features of the locating feature discussed above.

The first locating feature may comprise an abutment, the first chassis may comprise a cooperating surface, and the abutment may abut the cooperating surface to locate the aerosol generating assembly on the first chassis.

The second locating feature may comprise at least one protrusion, the first chassis may comprise at least one socket, and the at least one protrusion may be received by the at least one socket to locate the aerosol generating assembly on the first chassis.

The second chassis comprising the locating arrangement may be integrally formed.

The device may comprise an end support at one end of the second chassis. The device may comprise an air passage passing through the heater assembly and the end support. The second chassis may comprise an orientation feature configured to restrict rotation of the end support relative to the second chassis.

The pair of arms may be configured to grip the end support therebetween.

The second chassis may be a tubular member.

The heater assembly may comprise a receptacle configured to receive the aerosol generating material. The receptacle may comprise the susceptor. The air passage may pass through the receptacle. The air passage may pass through the susceptor.

According to an aspect of the present disclosure, there is provided an aerosol provision device, comprising: a first chassis; and an aerosol generating assembly, the aerosol generating assembly comprising: a second chassis; and a heater assembly including a receptacle configured to receive aerosol generating material; the second chassis extending around the receptacle; wherein the second chassis comprises a locating arrangement configured to locate the aerosol generating assembly on the first chassis.

According to an aspect of the present disclosure, there is provided an aerosol provision device, comprising: a receptacle configured to receive aerosol generating material, wherein the receptacle comprises a susceptor which is heatable by penetration with a varying magnetic field; a coil support extending around the susceptor; an inductor coil extending around the coil support, wherein the inductor coil is configured to generate the varying magnetic field; an end support at one end of the coil support; and an air passage passing through the receptacle and the end support; wherein the coil support comprises an orientation feature configured to restrict rotation of the end support relative to the coil support.

The end support may comprise an air inlet for the air passage. In use, air may pass into air passage through the air inlet.

The end support may comprise a stop configured to cooperate with the orientation feature so as to restrict rotation of the end support relative to the coil support.

The orientation feature may comprise a slot, and the stop may comprise a protrusion engaging the slot so as to restrict rotation of the end support relative to the coil support.

The slot may extend in the axial direction. Correspondingly, the protrusion may extend in the axial direction.

The coil support comprising the orientation feature may be integrally formed.

The device may comprise a housing. The housing may at least partially house the first chassis and the aerosol generating assembly. The housing may be connected to the device such that the position of the housing is fixed with respect to the first chassis. The housing may be rigidly connected to the first chassis.

The device may comprise at least one electronics module. The at least one electronics module may be connected to the device such that the position of the at least one electronics module is fixed with respect to the first chassis. The at least one electronics module may be rigidly connected to the first chassis.

The first chassis may be a rigid member.

The device may comprise a flexible battery, such as a soft pouch cell. The first chassis may at least partially surround the battery.

The device may comprise an insulating layer extending around the susceptor, between the susceptor and the second chassis.

The first chassis may comprise a mount for at least one electrical connector. The at least one electrical connector may comprise a charging port, such as a USB charging port.

The coil support comprising the locating arrangement and the orientation feature may be integrally formed.

The coil support may be a tubular member.

The coil support may comprise an alignment feature configured to align the inductor coil on the coil support. The alignment feature may comprise a channel. The inductor coil may be at least partially received in the channel along at least part of the length of the channel.

The inductor coil may be configured to heat the susceptor to a temperature of between about 200 and about 300° C. In embodiments, the inductor coil may be configured to heat the susceptor to a temperature of about 350° C.

According to an aspect of the present disclosure, there is provided an inductor coil support for an aerosol provision device comprising a chassis, the inductor coil support comprising at least one locating feature configured to locate the inductor coil support on the chassis.

The at least one locating feature may have the features of the locating feature discussed above.

According to an aspect of the present disclosure, there is provided an aerosol provision system comprising: an aerosol provision device as described above; and an article comprising aerosol generating material, wherein the article is dimensioned to be at least partially received within the (receptacle of the) heater assembly.

The article may be dimensioned to be at least partially received within the susceptor.

The article may be dimensioned to be in contact with the susceptor when received within the susceptor.

In a particular arrangement the susceptor may be elongate and define an axis, such as a longitudinal axis. The coil support may therefore be positioned radially outward from the susceptor, for example the coil support may be coaxial with the susceptor. This radial direction may be defined as being perpendicular to the axis of the susceptor. The inductor coil may be coaxial with the insulating member and the susceptor (i.e. an axis of the inductor coil, insulating member, and susceptor may be coincidental and parallel).

The inductor coil may be substantially helical. The inductor coil may be a spiral coil. For example, the inductor coil may be formed from wire, such as Litz wire, which is wound helically around the coil support. Other wire types are anticipated, such as solid.

Reference to an “outer surface” of an entity means the surface positioned furthest away from the axis of the susceptor, in a direction perpendicular to the axis. Similarly, reference to an “inner surface” of an entity means the surface positioned closest to the axis of the susceptor, in a direction perpendicular to the axis.

Reference to the “thickness” of an entity means the average distance between the inner surface of the entity and the outer surface of the entity. Thickness may be measured in a direction perpendicular to the axis of the susceptor.

The inductor coil, the susceptor and the second chassis may be coaxial.

In some examples, in use, the inductor coil is configured to heat the susceptor to a temperature of between about 200° C. and about 350° C., such as between about 240° C. and about 300° C., or between about 250° C. and about 280° C. When an outer cover is spaced apart from the susceptor by a suitable distance, the temperature of the outer cover may remain at a safe level, such as less than about 60° C., less than about 50° C., or less than about 48° C., or less than about 43° C.

The first and/or second chassis may be constructed from any insulating material, such as plastic for example. In a particular example, the first and second chassis is constructed from polyether ether ketone (PEEK). PEEK has good insulating properties and is well suited for use in an aerosol provision device.

In another example, the first and/or second chassis may comprise mica or mica-glass ceramic.

The first and/or second chassis may have a thermal conductivity of less than about 0.5 W/mK, or less than about 0.4 W/mK. For example, the thermal conductivity may be about 0.3 W/mK. PEEK has a thermal conductivity of about 0.32 W/mK.

The first and/or second chassis may have a melting point of greater than about 320° C., such as greater than about 300° C., or greater than about 340° C. PEEK has a melting point of 343° C.

The device may be a tobacco heating device, also known as a heat-not-burn device.

Further features and advantages of the disclosure will become apparent from the following description of embodiments of the disclosure, given by way of example only, which is made with reference to the accompanying drawings.

### BRIEF DESCRIPTION OF THE DRAWINGS

FIG. 1 shows a front view of an example of an aerosol provision device;

FIG. 2 shows a partially exploded side view of the aerosol provision device of FIG. 1 showing a first chassis, end members, power source, aerosol generating assembly, replaceable article, and outer cover;

FIG. 3 shows a close up cross-sectional side view of part of the aerosol provision device of FIG. 1;

FIG. 4 is a close up cross sectional view showing part of the aerosol generating assembly of FIG. 2;

FIG. 5 is another close up cross sectional view showing a proximal part of the aerosol generating assembly of FIG. 2;

FIG. 6 is another close up cross sectional view showing a distal part of the aerosol generating assembly of FIG. 2;

FIG. 7 is another close up cross sectional view showing part of the aerosol generating assembly of FIG. 2;

FIG. 8 is another close up cross sectional view showing part of the aerosol generating assembly of FIG. 2;

FIG. 9 shows a side view of the aerosol generating assembly of FIG. 2 including inductor coils and second chassis comprising a coil support;

FIG. 10 shows a side view of the coil support of FIG. 9;

FIG. 11 is a side view of the first chassis and aerosol generating assembly of FIG. 2;

FIG. 12 is a close up side view of part of the coil support of FIG. 4 showing a thermocouple mount;

FIG. 13A is a close up view of a proximal end of the second chassis comprising the coil support;

FIG. 13B is a close up view of a distal end of the second chassis comprising the coil support;

FIG. 14A is a close up view of a proximal end of the second chassis comprising the coil support located on the first chassis;

FIG. 14B is a close up view of a distal end of the second chassis comprising the coil support located on the first chassis; and

FIG. 15 shows an end support having an orientation feature.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

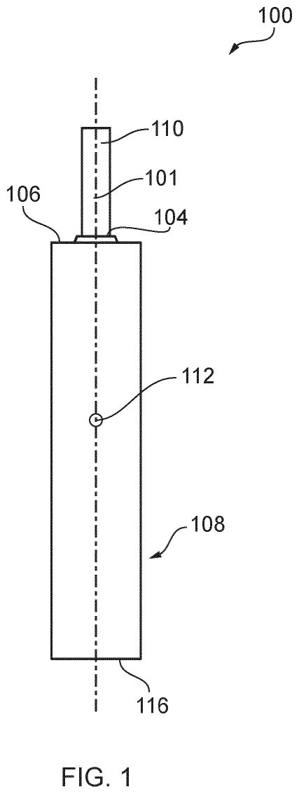

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

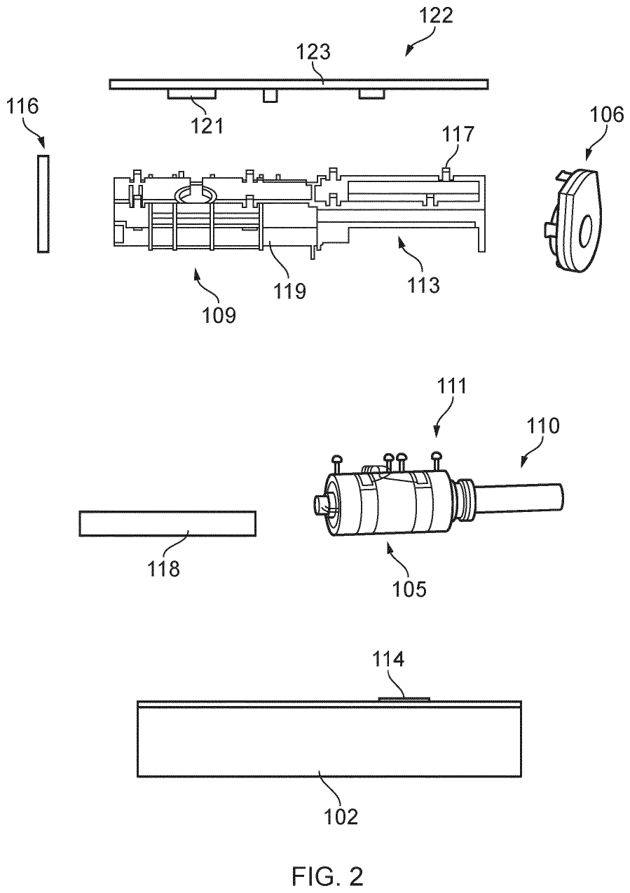

The device 100 comprises a housing 102 (including an outer cover) which surrounds and houses various components of the device 100. The device 100 has an opening 104 in one end, through which the article 110 may be inserted for heating by a heater assembly 105 (refer to FIG. 2). In use, the article 110 may be fully or partially inserted into the heater assembly 105 where it may be heated by one or more components of the heater assembly 105.

The device 100 may also include a user-operable control element 112, such as a button or switch, which operates the device 100 when pressed. For example, a user may turn on the device 100 by operating the switch 112.

The device 100 defines a longitudinal axis 101.

FIG. 2 depicts a schematic exploded view of the device 100 of FIG. 1. The device 100 comprises the outer cover 102, a first end member 106 and a second end member 116. The device 100 includes a chassis 109, a power source 118, and an aerosol generating assembly 111 including the heater assembly 105. The device 100 further comprises at least one electronics module 122.

The outer cover 102 forms part of a device shell 108. The first end member 106 is arranged at one end of the device 100 and the second end members 116 is arranged at an opposite end of the device 100. The first and second end members 106, 116 close the outer cover 102. The first and second end members 106, 116 form part of the shell 108. The device 100 in embodiments comprises a lid (not shown) which is moveable relative to the first end member 106 to close the opening 104 when no article 110 is in place.

The device 100 may also comprise an electrical component, such as a connector/port 114, which can receive a cable to charge a battery of the device 100. For example, the connector 114 may be a charging port, such as a USB charging port. In some examples the connector 114 may be used additionally or alternatively to transfer data between the device 100 and another device, such as a computing device.

The device 100 includes the chassis 109. The first chassis 109 may comprise a mount for the connector/port 114. The chassis 109 is received by the outer cover 102. The housing including outer cover 102 may be connected to the device 100 such that the position of the outer cover 102 is fixed with respect to the chassis 109. For example, the outer cover 102 may be rigidly connected to the chassis 109. The aerosol generating assembly 111 comprises the heater assembly 105 into which, in use, the article 110 may be fully or partially inserted where it may be heated by one or more components of the heater assembly 105. The aerosol generating assembly 111 and the power source 118 are mounted on the chassis 109. The chassis 109 is a one piece component. The chassis 109 may be a rigid member. The chassis 109 may thus provide protection to components of the device mounted therewithin, in particular components which are relatively soft.

The chassis 109 may be formed together during manufacture, for example through an injection molding process. Alternatively, two or more features of the chassis 109 may be separately formed initially and then formed together during a manufacturing stage to form a one-piece component, for example by a welding process.

One-piece component refers to a component of the device 100 which is not separable into two or more components following assembly of the device 100. Integrally formed relates to two or more features that are formed into a one piece component during a manufacturing stage of the component.

The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. The first and second end members 116 close open ends of the outer cover 102. The second end member 116 is at one end of the chassis 109.

The end of the device 100 closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The power source 118 is disposed at the distal end of the device 100. The chassis 109 mounts the power source 118. The chassis 109 comprises a power supply mount 119. The chassis 109 partially encloses the power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery may be flexible, such as a soft pouch cell. The (relatively more rigid) first chassis 109 may at least partially surround the battery, and thus may provide protection for the battery. The battery is electrically coupled to the aerosol generating assembly 111 to supply electrical power when required and under control of a controller 121 to heat the aerosol generating material. In this example, the battery is connected to the chassis 109, acting as a central support, which holds the battery 118 in place.

The power source 118 and aerosol generating assembly 111 are disposed in an axial arrangement, with the power source 118 at the distal end of the device 100 and the aerosol generating assembly 111 at the proximal end of the device 100. Other configurations are anticipated. The chassis 109 comprises an aerosol generating assembly mount 113.

The device 100 further comprises at least one electronics module 122. The electronics module 122 may comprise, for example, a printed circuit board (PCB) 123. The PCB 123 may support at least one controller 121, such as a processor, and memory. The PCB 123 may also comprise one or more electrical tracks to electrically connect together various electronic components of the device 100. For example, the battery terminals may be electrically connected to the PCB 123 so that power can be distributed throughout the device 100. The connector 114 may also be electrically coupled to the battery 118 via the electrical tracks. The chassis 109 comprises a PCB mount 117. The at least one electronics module 122 may be connected to the device 100 such that the position of the at least one electronics module 122 is fixed with respect to the first chassis 109. For example, the at least one electronics module 122 may be rigidly connected to the first chassis 109.

The aerosol generating assembly 111 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

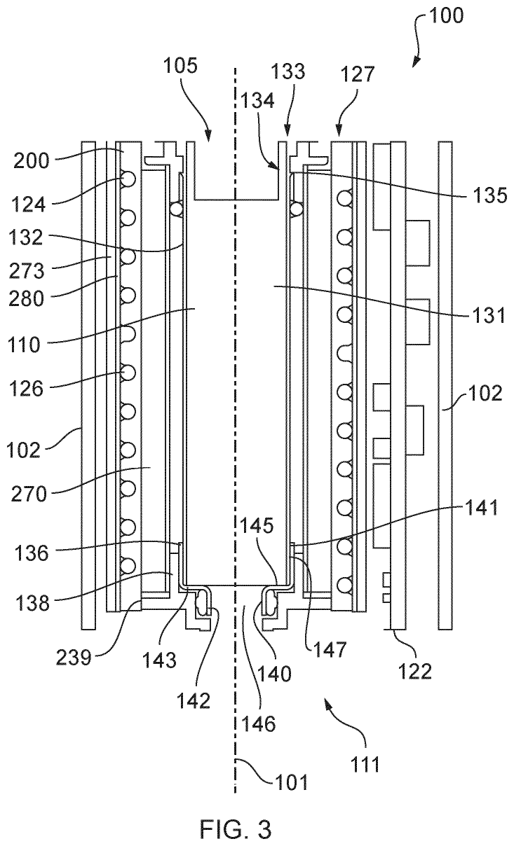

FIG. 3 shows a close up side view of part of the device 100 in partial cross-section. The outer cover 102 encloses the aerosol generating assembly 111. The aerosol generating assembly 111 of the device 100 comprises the heater assembly 105 and an inductor coil assembly 127. The inductor coil assembly 127 extends around the heater assembly 105. The inductor coil assembly 127 includes a first inductor coil 124 and a second inductor coil 126. The inductor coil assembly 127 also comprises a second chassis comprising a coil support 200.

The heater assembly 105 includes a susceptor arrangement 132 (herein referred to as “a susceptor”). The susceptor 132 of this example is hollow and therefore defines a receptacle 131 within which aerosol generating material is received. For example, the article 110 can be inserted into the susceptor 132. In this example the susceptor 132 is tubular, with a circular cross section. The susceptor 132 defines a first portion of the heater assembly 105. The susceptor 132 has a generally constant diameter along its axial length. The susceptor 132 has a flared portion 134 at a first, proximal, end 133. The flared portion 134 diverges outwardly. The flared portion 134 defines an outwardly extending lip 135. That is the lip 135 has a greater diameter than the outer diameter of the main portion of the susceptor 132. The lip 135 acts to minimize contact of the susceptor 132 with other components at the first end 133. This arrangement helps with a low heat transmission, for example through conduction, when the susceptor 132 is heated.

The susceptor 132 is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the receptacle may not be limited to being inductively heated. The feature, acting as a heating element, may therefore be heatable by electrical resistance. The heater assembly 105 may therefore comprise electrical contacts for electrical connection with the apparatus for electrically activating the heating element by passing a flow of electrical energy through the heating element.

FIG. 3 shows a portion of the article 110 received within the receptacle 131 provided by the susceptor 132. The susceptor 132 and article 110 are dimensioned so that the outer surface of the article 110 abuts the inner surface of the susceptor 132. This helps ensure that the heating is most efficient. The article 110 of this example comprises aerosol generating material. The aerosol generating material is positioned within the susceptor 132. The article 110 may also comprise other components such as a filter, wrapping materials and/or a cooling structure.

The heater assembly 105 also comprises a funnel part 140. The funnel part 140 is at a second, distal, end 136 of the susceptor 132. The funnel part 140 protrudes from the susceptor 132. In embodiments, the susceptor 132 and funnel part 140 are a one-piece component.

The funnel part 140 has a thimble arrangement. The funnel part 140 is at the second, distal, end 136 of the susceptor 132. The funnel part 140 defines a second portion of the heater assembly 105. The funnel part 140 comprises a first section 141 having a first diameter and a second section 142 having a second diameter. An intermediate section 143 extends between the first and second sections 141, 142. The first section 141 is tubular and extends in the axial direction. The second section 142 is tubular and extends in the axial direction. The funnel part 140 is hollow. The intermediate section 143 forms a shoulder 145. The shoulder 145 acts as a stop to limit insertion of the article 110 into the receptacle. The shoulder 145 extends on a substantially perpendicular plane to the longitudinal axis 101.

The first section 141 has an inner diameter which is greater than the inner diameter of the second section 142. The funnel part 140 therefore converges from the first section 141 to the second section 142. The funnel part 140 therefore reduces in diameter from a susceptor end 148 to a distal end 149.

The funnel part 140 defines an air passage 146 therethrough. The first section 141 and the susceptor 132 partially overlap with each other at one end of the susceptor 132. In an example, the overlap is between about 1 mm and about 3 mm. In this particular example, the overlap is 2 mm. In examples, there is no overlap. In such an example the susceptor 132 and funnel part 140 abut. The first section 141 overlaps the second, distal, end 136 of the susceptor 132. The first section 141 is generally cylindrical and has an inner diameter substantially corresponding to the outer diameter of the susceptor 132. The first section 141 abuts the susceptor 132. A juncture 147 is formed between the first section 141 of the funnel part 140 and the susceptor 132. The juncture 147 assists with forming a thermally conductive path between the susceptor 132 and the funnel part 140.

The juncture 147 is a fluidly sealed juncture. A fluid seal is formed between the susceptor 132 and the funnel part 140. As such a fluidly sealed fluid path is defined between the opposing ends of the susceptor 132 and the funnel part 140. The receptacle defined by the susceptor 132 therefore forms a fluid seal air path with the air passage 146 formed by the funnel part 140.

The fluid seal at the juncture 147 is formed in embodiments by a mechanical fabricated joint, for example a weld. The fluid seal at the juncture 147 is formed by a laser weld process, however it will be understood that other methods may be used such as brazing and adhering. The funnel part 140 is formed from a thermally conductive material. In embodiments, the funnel part 140 is formed from a carbon steel. The funnel part in embodiments is formed from the same material as the susceptor 132. The juncture is configured to retain a fluid seal when the susceptor 132 is at its predetermined operating temperature. By such processes the susceptor 132 and funnel part 140 are fabricated as a one-piece component.

The sealed fluid path between the susceptor 132 and the funnel part 140 therefore extends through the heater assembly 105 from one open end of the heater assembly 105 to the other open end of the heater assembly 105. As such, any fluid flow through the heater assembly 105 is contained in the heater assembly 105. A dry zone may be defined outside the heater assembly 105.

The abutment of the susceptor 132 and the funnel part 140 provides for heat transfer by conduction from the susceptor 132 to the funnel part 140. As such, it is possible to aid passive heating of the funnel part 140. By passively heating the funnel part 140 it is possible to restrict the build up of condensate in the device 100.

The funnel part 140 is axially spaced from the inductor coil assembly 127. In particular, the second section 142 of the funnel part 140 is axially spaced from the inductor coil assembly 127. As such, there is minimal or no direct heating of the funnel part 140 by the inductor coil assembly 127. The funnel part 140 may lie adjacent to the inductor coil assembly 127 in an axial direction.

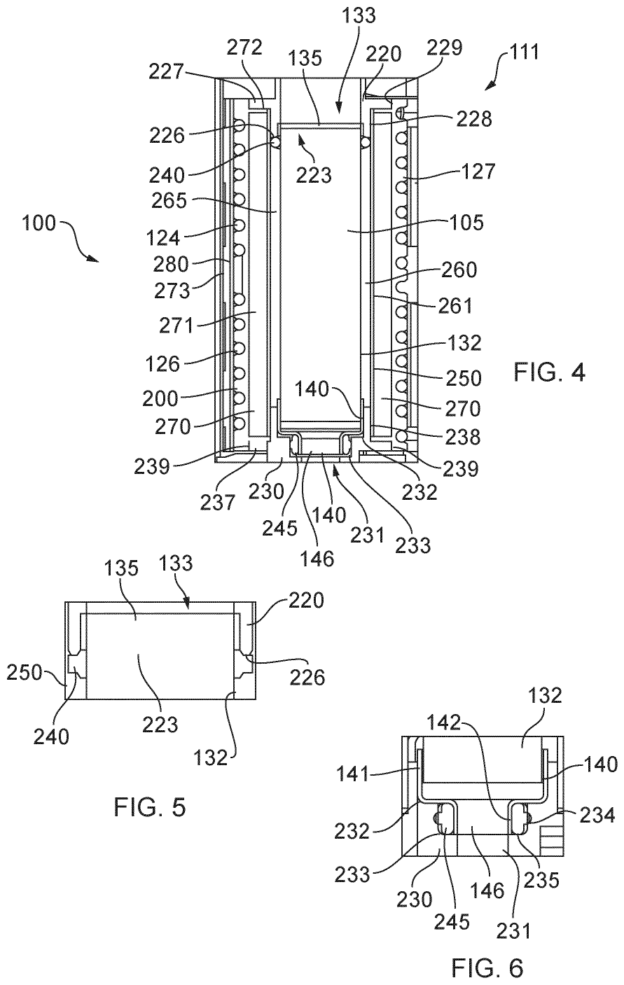

Referring in particular to FIGS. 4 to 8, the device 100 comprises a first end support 220 and a second end support 230. The heater assembly 105 extends between the first and second end supports 230. A barrier member 250 extends between the first end support 220 and the second end support 230. The barrier member 250 acts as a support member.

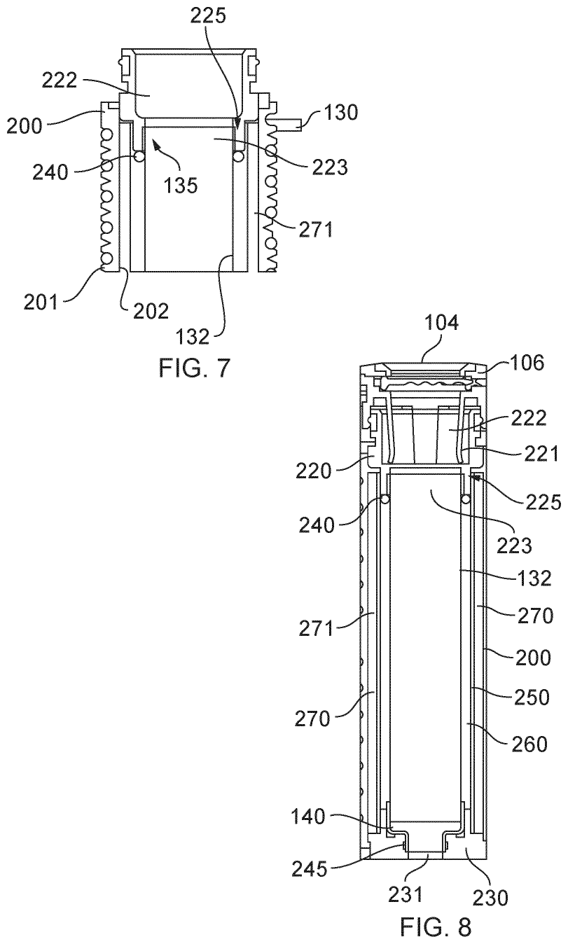

The first end support 220 engages the first, proximal, end of the heater assembly 105 to hold the susceptor 132 in place. The first end support 220 acts as an expansion chamber, as described below. Referring to FIGS. 7 and 8 in particular, the first end support 220 extends away from the first end of the susceptor 132 towards the opening 104 of the device. Located at least partially within the first end support 220 is a retention arrangement 221, such as a retention clip, to abut and hold the article 110 when received within the device 100. The first end support 220 is connected to the end member 106.

The first end support 220 comprises a chamber 222. The chamber 222 is configured to receive the article 110 therethrough. The retention arrangement 221 is in the chamber 222. The chamber 222 has an inner diameter greater than the diameter of the article 110. The first end support 220 forms a first, proximal, collar for the heater assembly 105. A bore 223 extends therethrough. As shown, for example, in FIGS. 7 and 8, a distally facing shoulder 225 is defined on the inner surface of the bore 223. The distally facing shoulder 225 locates with the lip 135 of the susceptor 132 when the susceptor is received by the first end support 220.

Referring now in particular to FIGS. 4 and 5, the first end support 220 forms a sealing rim 226 on a distal side of the first end support 220. The distal sealing rim 226 extends about the bore 223. A first mounting flange 227 extends from a first, proximal, end outer surface 228 of the first end support 220. The first mounting flange 227 extends circumferentially and is spaced from the sealing rim 226. The first mounting flange 227 upstands from the first end outer surface 228 and forms a first, proximal, end mounting surface 229. The first, proximal, end outer surface 228 and the first end mounting surface 229 define a stepped configuration. The first end mounting surface 229 has a greater diameter than the first end outer surface 228. In embodiments, the first end outer surface 228 and first end mounting surface define first and second step faces.

Referring in particular to FIGS. 4 to 8, the device 100 further comprises the second end support 230 which engages the funnel part 140 at the second, distal, end of the susceptor 132 to hold the heater assembly 105 in place. The second end support 230 forms a second, distal, collar for the heater assembly 105. In embodiments in which the funnel part is omitted, the second end support 230 engages the susceptor 132 directly. The second end support 230 acts as an air inlet, as will be described below. The second end support 230 extends away from the second end of the susceptor 132 towards the distal end of the device 100.

Referring in particular to FIGS. 4 and 6, the second end support 230 comprises a second end bore 231. The second end support 230 is configured to at least partially receive the funnel part 140. The inner surface of the second end support 230 is stepped. The inner surface comprises a first stepped region 232 with a first step, and a second stepped region 233 with a second step. The first stepped region 232 receives the first section 141 of the funnel part 140. The second stepped region 233 receives the second section 142 of the funnel part 140. The second stepped region 233 includes a first sealing face 234. The second stepped region 233 includes a second sealing face 235. The first sealing face 234 is an internal circumferentially extending face. The second sealing face 235 is a circumferentially extending face extending on a plane substantially perpendicular to the longitudinal axis 101.

A second mounting flange 237 extends from a second, distal, outer surface 238 of the second end support 230. The second mounting flange 237 extends circumferentially and is spaced from a proximal end of the second end support 230. The second mounting flange 237 upstands from the second end outer surface 238 and forms a second, distal, end mounting surface 239. The second, distal, end outer surface 238 and the second, distal, end mounting surface 239 define a stepped configuration. The second end mounting surface 239 has a greater diameter than the second end outer surface 238. In embodiments, the second end outer surface 238 and second end mounting surface 239 define first and second step faces.

The barrier member 250 extends between the first end support 220 and the second end support 230. The barrier member 250 extends between the first and second end supports 220, 230. The barrier member 250 together with the first and second end supports 220, 230 encloses the heater assembly 105. This acts to assist with thermally isolating the heater assembly 105 from other components of the device 100. The barrier member 250 is a hollow, tubular member.

The barrier member 250 is fixedly mounted to the first and second end supports 220, 230. The first and second end supports, 220, 230 are received in the ends of the barrier member 250. The first end support 220 closes the proximal end of the barrier member 250. The second end support 230 closes the distal end of the barrier member 250. The barrier member 250 partially overlaps the first and second end supports, 220, 230. In an example, the overlap is between about 2 mm and about 3 mm. In this particular example, the overlap is about 2.2 mm. In examples, there is no overlap. The proximal end of the barrier member 250 abuts the first end outer surface 228. The distal end of the barrier member 250 abuts the second end outer surface 238.

The barrier member 250 is fixedly mounted to the first and second end supports 220, 230. The barrier member 250 forms a fluid seal with the first and second end supports 220, 230. In embodiments a mechanical fabricated joint, for example a weld, is formed between the barrier member 250 and each of the first and second end supports 220, 230. The fluid seal at the junction of the parts is formed by a weld process, however it will be understood that other methods may be used such as brazing and adhering. In embodiments, the barrier member 250, and first and second end supports 220, 230 are formed from the same material. The junction is configured to retain a fluid seal when the susceptor 132 is at its predetermined operating temperature. By such a process the barrier member 250 and the first and second end supports 220, 230 are formed as a one-piece component.

In embodiments, the barrier member 250 is formed from a non-metallic material to assist with limiting interference with magnetic induction. In this particular example, the barrier member 250 is constructed from polyether ether ketone (PEEK). The first and second end supports 220, 230 are constructed from PEEK. Other suitable materials are possible. Parts formed from such materials help ensure that the barrier member 250 remains rigid/solid when the susceptor is heated. The barrier member 250 is formed from a rigid material to aid support of other components, such as the heater assembly 105 and the end supports 220, 230. The barrier member 250 may be constructed from an insulating material, such as plastic for example. In an example, the barrier member 250 has a thickness between about 0.1 mm and about 0.5 mm. In the present example, the thickness is about 0.3 mm.

The heater assembly 105, the barrier member 250, and the first and second end supports 220, 230 are coaxial around the central longitudinal axis of the susceptor 132. The barrier member 250 may help insulate the various components of the device 100 from the heat generated in the susceptor 132.

A radial gap is provided between the susceptor 132 and the first end support 220. The diameter of the bore 223 is greater than the diameter of the external face of the susceptor 132. The radial gap is approximately 0.2 mm, although the gap may differ. The provision of the radial gap aids with minimizing heat transfer between the susceptor 132 and the first end support 220.

Referring now in particular to FIGS. 4 to 6, a first sealing member 240 forms a fluid seal between the heating assembly 105 and the first end support 220. The first sealing member 240 is a circumferentially extending member. The first sealing member 240 comprises a silicon rubber seal. Other suitable materials may be used. The first sealing member 240 is resilient. The material is configured to be stable when the heating assembly 105 is at operating temperature. The first sealing member 240 is fixedly mounted on the susceptor 240. The first sealing member 240 is adhered to the susceptor 132, for example by overmolding of the first sealing member 240 on the outer surface of the susceptor 132. The first sealing member 240 is spaced from the proximal end of the susceptor 132. When the proximal end of the susceptor 132 is received by the first end support 220, the sealing rim 226 of the first end support 220 abuts with and seals against the first sealing member 240. As such a seal is formed between the first end support 220 and the susceptor 220. The first sealing member 240 forms a seal in the axial direction.

The first sealing member 240 abuts with and seals against the barrier member 250. The first sealing member 240 upstands from the susceptor 132. The first sealing member 240 abuts the internal surface of the barrier member 250. Accordingly, a seal is formed between the susceptor 132 and the barrier member 250. The first sealing member 240 forms a seal in the radial direction. The first sealing member 240 acts to locate and orientate the susceptor with respect to the first end support 220 and the barrier member 250.

A second sealing member 245 forms a fluid seal between the heating assembly 105 and the second end support 230. The second sealing member 245 is a circumferentially extending member. The second sealing member 245 comprises a silicon rubber seal. Other suitable materials may be used. The second sealing member 245 is resilient. The material is configured to be stable when the heating assembly 105 is at operating temperature. The second sealing member 245 is fixedly mounted on the funnel part 140. In embodiments, the second sealing member is on the susceptor 132, for example where the funnel part is omitted. The second sealing member 245 is adhered to the susceptor 132, for example by overmolding of the second sealing member 245 on the outer surface of the funnel part 140. The second sealing member 245 is adjacent to the open end of the funnel part 140. When the distal end of the heating assembly is received by the second end support 230, the first sealing face 234 of the second end support 230 abuts with and seals against the second sealing member 245. As such a seal is formed between the second end support 230 and the heating assembly 105. The second sealing member 245 forms a seal in the radial direction.

The second sealing member 245 abuts with and seals against the second sealing face 235 of the second end support 230. The second sealing member 245 forms a seal in the axial direction. The second sealing member 245 upstands from the heater assembly 105. The second sealing member 245 acts to locate and orientate the heater assembly 105 with respect to the second end support 230 and the barrier member 250.

In embodiments, the first sealing member 240 is on the first end support 220 and seals with the heater assembly 105. In embodiments, the second sealing member 245 is on the second end support 230 and seals with the heater assembly 105. The second sealing member 245 is on the second section 142 of the funnel part 140. In embodiments, the second sealing member 245 is on the first section 141 of the funnel part 140. In such an embodiment, the second sealing member 245 seals against a proximal rim of the second end support 230.

The first sealing member 240 and second sealing member 250 form a sealed air flow path through the second sealing member 250, heater assembly 105 and first sealing member 240. The barrier member 250 and the first and second end supports 220, 230 form a contiguously sealed enclosure for the heater assembly 105. The barrier member 250 is spaced from the susceptor 132. An inner surface of the barrier member 250 is positioned away from the outer surface of the susceptor 132 to provide an air gap between the barrier member 250 and the heater assembly 105. The air gap provides insulation from the heat generated in the susceptor 132.

A fluidly sealed cavity 260 is formed between the heater assembly 105 and the barrier member 250. The fluidly sealed cavity 260 forms a chamber. The cavity 260 provides an air gap. A fluidly sealed enclosure 261 is formed around part of the heater assembly 105. The fluidly sealed enclosure is formed by the barrier member 250, first and second sealing members 240, 245, heater assembly 105 and the second end support 230. In some embodiments, the first end support 220 forms part of the enclosure 261. In some embodiments, the fluidly sealed enclosure 261 is formed by the barrier member 250, heater assembly 105 and first and second sealing members 240, 245. In embodiments, the gap between the heater assembly 105 and the barrier member 250 is between about 0.8 mm and 1 mm. In embodiments, the gap is about 0.9 mm.

A sensor, such as a thermocouple 265, is disposed in the fluidly sealed cavity 260. The thermocouple 265 is mounted on the susceptor 132. The thermocouple 265 is configured to determine the temperature of the susceptor 132. The thermocouple 265 directly detects the temperature of the susceptor 132. The device 100 may comprise two or more thermocouples 132 configured to determine the temperature of the susceptor 132. The provision of the fluidly sealed cavity 260 helps to isolate the thermocouples 265 from atmosphere external to the fluidly sealed cavity 260. The provision of the fluidly sealed cavity 260 helps to isolate the thermocouples 265 from the air flow path through the device 100. As such, condensate from the air flow path is restricted from flowing to the thermocouples 265.

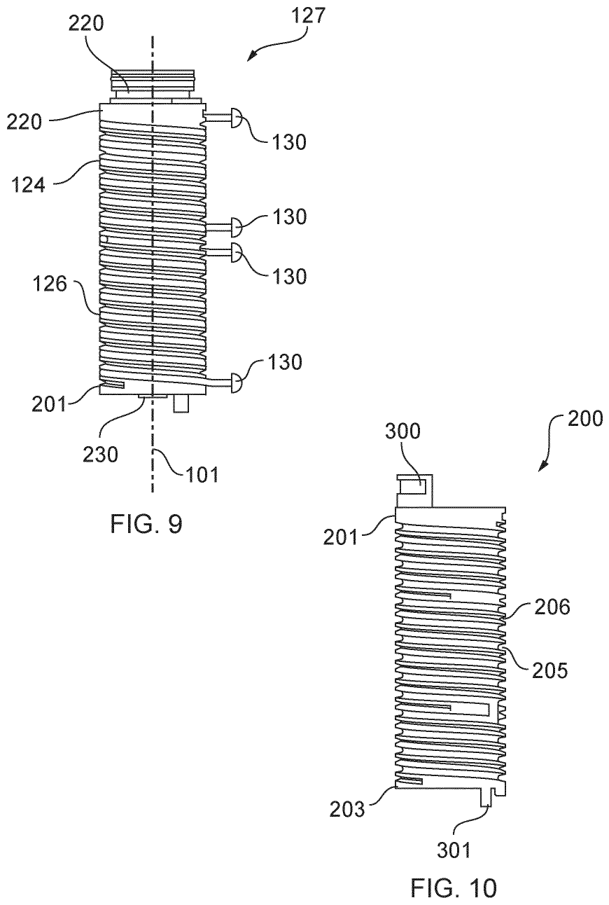

Referring to FIGS. 9 and 10 in particular, the inductor coil assembly 127 includes the first inductor coil 124 and the second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a circular cross section. In other examples the Litz wire can have other shape cross sections, such as rectangular. The number of inductor coils may differ. For example, in embodiments the inductor coil assembly 127 may include a single inductor coil. The first or second inductor coil may be omitted.

The first inductor coil 124 is configured to generate a first varying magnetic field for heating a first section of the susceptor 132 (refer to FIG. 4) and the second inductor coil 126 is configured to generate a second varying magnetic field for heating a second section of the susceptor 132. In this example, the first inductor coil 124 is adjacent to the second inductor coil 126 in a direction along the longitudinal axis 101 of the device 100 (that is, the first and second inductor coils 124, 126 do not overlap). The susceptor arrangement 132 may comprise a single susceptor, or two or more separate susceptors. Ends 130 of the first and second inductor coils 124, 126 can be connected to the PCB 123 (refer to FIG. 2).

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIGS. 3 and 4, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in the same direction. The inductor coils may be active at different times. For example, initially, the first inductor coil 124 may be operating to heat a first section of the article 110, and at a later time, the second inductor coil 126 may be operating to heat a second section of the article 110. In embodiments, the first inductor coil 124 and the second inductor coil 126 are wound in opposite directions. Winding the coils in opposite directions helps reduce the current induced in the inactive coil when used in conjunction with a particular type of control circuit. In such an embodiment, the first inductor coil 124 may be a right-hand helix and the second inductor coil 126 may be a left-hand helix. In another embodiment, the first inductor coil 124 may be a left-hand helix and the second inductor coil 126 may be a right-hand helix.

It will be understood that the number of inductor coils may differ. In embodiments, the device 100 comprises a single inductor coil.

The device 100 comprises the second chassis. The second chassis comprises the coil support 200 acting as a support member. The support member may be generally tubular and at least partially surround the susceptor 132. The second chassis 200 supports the first and second inductor coils 124, 126. The second chassis 200 is shown in cross-section in FIG. 4. A side view of the second chassis 200 is shown with various parts of the device 100 omitted in FIG. 9. The second chassis 200 is shown in FIG. 10.

The second chassis 200 extends between the first and second end supports 220, 230. The second chassis 200 together with the first and second end supports 220, 230 encloses the heater assembly 105. This acts to assist with thermally isolating the heater assembly 105 from other components of the device 100. The coil support 200 is a hollow, tubular member.

In embodiments, the coil support 200 is formed from a non-metallic material to assist with limiting interference with magnetic induction. In this particular example, the second chassis 200 is constructed from polyether ether ketone (PEEK). Other suitable materials are possible. The second chassis formed from such materials ensure that the assembly remains rigid/solid when the susceptor is heated. The coil support 200 is formed from a rigid material to aid support of other components, such as the coils 124, 126. The coil support 200 may be constructed from an insulating material, such as plastic for example. In an example, the coil support 200 has a thickness between 1 mm and 1.5 mm. In the present example, the thickness is about 1.3 mm.

As shown in FIGS. 3, 4 and 9 in particular, the first and second inductor coils 124, 126 are positioned around the coil support 200 and abut the coil support 200. The first and second inductor coils 124, 126 are on a radially outward side 201 of the coil support 200. In embodiments, the first and second inductor coils are on a radially inward side 202 of the coil support 200.

The susceptor 132, the coil support 200, and the first and second inductor coils 124, 126 are coaxial around the central longitudinal axis 101 of the susceptor 132. The coil support 200 may help insulate the various components of the device 100 from the heat generated in the susceptor 132.

The coil support 200 has an outer surface 203. The outer surface 203 is spaced away from the outer cover 102. The coil support 200 is spaced from the heater assembly 105. The coil support 200 has an inner surface which is positioned away from the outer surface 203 of the susceptor 132.

The second chassis is fixedly mounted to the first and second end supports 220, 230. The first and second end supports, 220, 230 are received in the ends of the coil support 200. The first end support 220 closes the proximal end of the coil support 200. The second end support 230 closes the distal end of the coil support 200. The coil support 200 partially overlaps the first and second end supports, 220, 230. The proximal end of the barrier member 250 abuts the first end outer surface 228. The distal end of the barrier member 250 abuts the second end outer surface 238. The proximal end of the coil support 220 overlaps the first, proximal, end mounting surface 229 of the first end support 220. The distal end of the coil support 220 overlaps the second, distal, end mounting surface 229 of the second end support 230.

The coil support 200 is fixedly mounted to the first and second end supports 220, 230. The coil support 200 is retained between the first and second end supports 220, 230. In embodiments a mechanical fabricated joint, such as welding or adhering fixes the coil support 200 in place. In embodiments, the coil support 200, and first and second end supports 220, 230 are formed from the same material.

Referring in particular to FIGS. 3, 4, 9 and 10, the first and second inductor coils 124, 126 are aligned on the coil support 200 by the coil support 200. That is, the first and second inductor coils 124, 126 are retained in a specific arrangement with respect to the coil support 200 by a feature of the coil support 200. The alignment feature in examples is a channel 205. The channel 205 is formed in the radially outward side 201 of the coil support 200. The channel 205 is a helical channel 205. The channel 205 receives the first and second inductor coils 124, 126. The first and second inductor coils 124, 126 are retained by the channel 205. The channel 205 follows a constant helical path. The channel 205 comprises a plurality of turns around the coil support 200. The channel 205, acting as an alignment feature provides for a consistent path of the coils 214, 216, for example consistent spacing. This helps the performance of the inductor coil assembly to be maximized, and/or for a predetermined attribute of the coil to be achieved.

Each of the first and second inductor coils 124, 126 are aligned on the coil support 200 in a helical arrangement. One of the inductor coils in examples may be omitted. Each of the first and second inductor coils 124, 126 follows a helical path. Turns of the helical path of each of the first and second inductor coils 124, 126 have equal spacing.

In embodiments, the helical channel 205 is formed by a groove in the outer surface 203 of the support coil 200. In embodiments, the helical channel 205 is formed by a pair of adjacent ridges extending in a helical arrangement. The ridges be non-continuous and may be formed from a plurality of protrusions. The protrusions may define a helical path in which the support coil is received and retained.

The coil support 200 comprises a helical recess 206 between adjacent turns of the channel 205. The helical recess 206 is an elongate groove. In examples, the helical recess 206 comprises a plurality of recess sections. The helical recess 206 in examples acts as an air gap. The provision of the helical recess aids with restricting heat transfer. The provision of the helical recess may aid weight minimization. The helical recess 206 forms a double helix configuration with the channel 205. In embodiments, the helical recess is omitted. The helical recess is not shown in FIGS. 3 and 4.

The first and second inductor coils 124, 126 are retained in the channel 205. Retention features such as clips, bonding, and an over layer may be used to retain the first and second inductor coils 124, 126 in the channel 205.

Each of the first and second inductor coils 124, 126 are fully received in the coil support 200. That is each of the first and second inductor coils 124, 126 lies planar with or recessed from the surface of the coil support 200. In embodiments, the first and second inductor coils 124, 126 partially protrude from the channel 205.

The coil support 200 comprises a single channel. However, it will be understood that the channel 205 may be separated into two channel portions, one for each coil 124, 126. Each channel may have one or more different properties, for example pitch, width, depth and length to provide a different alignment between the coils 124, 126.

A ferrite shield 280 extends around the inductor coils 124, 126. The ferrite shield acts as an electromagnetic shield. Other suitable materials may be used. The ferrite shield 280 is mounted on the coil support 200. The ferrite shield 280 abuts the coils support 200 and so may be directly mounted to the coil support 200, for example by adhering. The channel 205 provides for the coils 124, 126 to be recessed in the coil support 200. The inductor coils 124, 126 are enclosed by the coil support 200 and the ferrite shield 280.

Referring to FIG. 12, a sensor 290, such as a thermocouple, is positioned on the coil support 200. The coil support 200 comprises a sensor mount 291. This assists with accurately positioning the sensor with respect to the coil, and so aids accurate measurement. The mount 291 comprises a recess. The mount 291 forms a locating surface for mounting the thermocouple.

The alignment feature in the above described embodiments is the channel. However, it will be understood that the channel may be omitted and the alignment feature may vary.

In the above described embodiments, the coil support 200 is provided with the channel 205 for aligning the coils and/or other alignment features. It will be understood that in some embodiments the channel for aligning the coils and/or other alignment features may be omitted. In such an embodiment the coils may be adhered to a surface of the coil support, or may be assembled around the coil support with a gap therebetween.

The heater assembly 105, the barrier member 250, and the coil support 200 are coaxial around the central longitudinal axis of the susceptor 132. The coil support 200 may help insulate the various components of the device 100 from the heat generated in the susceptor 132.

The coil support 200 is spaced from the susceptor 132. The coil support 200 is spaced from the barrier member 250. The barrier member 250 is between the heater assembly 105 and the coil support 200. An insulation chamber 270 is formed between the coil support 200 and the barrier member 250.

In an example, the spacing between the coil support 200 and the barrier member 250 is between 0.5 mm and 1.5 mm. In the present example, the thickness is about 0.9 mm. The coil support 200 acts as a second barrier member. By providing barrier members, acting as barriers, in a spaced apart arrangement it is possible to help provide separate chambers to assist with isolating different components of the device from each other.

The barriers act as insulation members. As such, the barriers form part of an insulation stack to limit thermal transfer from the susceptor 132 to external of the aerosol generating assembly 111. The barrier member 250 acts as a first insulating member. The coil support 200 acts as a second insulating member. An insulating layer 271 extends between the barrier member 250 and the coil support 200. The insulating layer 271 extends around the barrier member 250. The insulating layer 271 abuts the barrier member 250 and the coil support 200.

In embodiments, the insulating layer 271 is supported by the barrier member 250 and the coil support 200. In some embodiments the insulating layer 271 is supported by the barrier member 250. In such embodiments, the insulating layer 271 may be spaced, for example by a small gap, from the coil support 200. In some embodiments the insulating layer 271 is supported by the coil support 200. In such embodiments, the insulating layer 271 may be spaced, for example by a small gap, from the barrier member 250. The insulating layer 271 may be attached to one or both of the barrier member 250 and coil support 200. In embodiments, the barrier member 250 may be omitted. In embodiments, the coil support 200 may be integrally formed with the insulating layer 271. The insulating layer 271 may be omitted. In such embodiments, an air gap is formed between the barrier member 250 and the coil support 200. In such an arrangement, the air gap acts as an insulator.

The insulating layer 271 acts as a third insulating member. The insulating layer is tubular. The insulating layer 271 may be a panel. The insulating layer 271 in embodiments is formed around the inner side of the coil support 200 in a tubular arrangement. End lips 272 (refer to FIG. 4) help to retain the insulating layer 271. The insulating layer 271 is adhered to the coil support 20. In examples, the insulating layer 271 is adhered to the barrier member 250. The barrier member 250 spaces the insulating layer 271 from the susceptor 132. The coil support 200 spaces the insulating layer 271 away from the inductor coils 124, 126.

The insulating stack may be provided by a combination of two or more of the following materials (i) air (which has a thermal conductivity of about 0.02 W/mK), (ii) Aerogel, for example AeroZero® (which has a thermal conductivity of between about 0.03 W/mK and about 0.04 W/mK), (iii) polyether ether ketone (PEEK) (which may have a thermal conductivity of about 0.25 W/mK in some examples), (iv) ceramic cloth (which has a specific heat of about 1.13 kJ/kgK), (v) thermal putty. Other suitable materials may be used.

The insulating layer 271 is formed from aerogel. Other suitable materials may be used, for example a porous foam material. By providing barrier members either side of the aerogel, for example, it is possible to provide a protective barrier for the insulating layer 271. The one or more barriers helps to support the insulating layer 271 along its length.

A combination of a barrier member with an aerogel insulating layer assists with providing an enhanced insulating configuration around the heater assembly 105 to restrict heat transfer to the shell of the device 100 in a compact arrangement.

The insulating layer 271 acts as an inner insulating layer 273. An outer insulating layer 273 extends around the inductor coil assembly 127. The outer insulating layer 273 forms a tubular arrangement. The outer insulating layer 273 is supported by the inductor coil assembly 127. The inner and outer insulating layers 271, 273 sandwich the inductor coil assembly 127. The outer insulating layer 273 is mounted on the ferrite layer 280. The outer insulating layer 273 is adhered to the ferrite layer 280, although other mounting arrangements are anticipated. By providing an outer insulating layer 273 allows for a predetermined thickness of insulation to be used whilst allowing for the distance between the coils and the susceptor 132 to be varied. The outer insulating layer 273 is formed from aerogel. Other suitable materials may be used, for example a porous foam material.

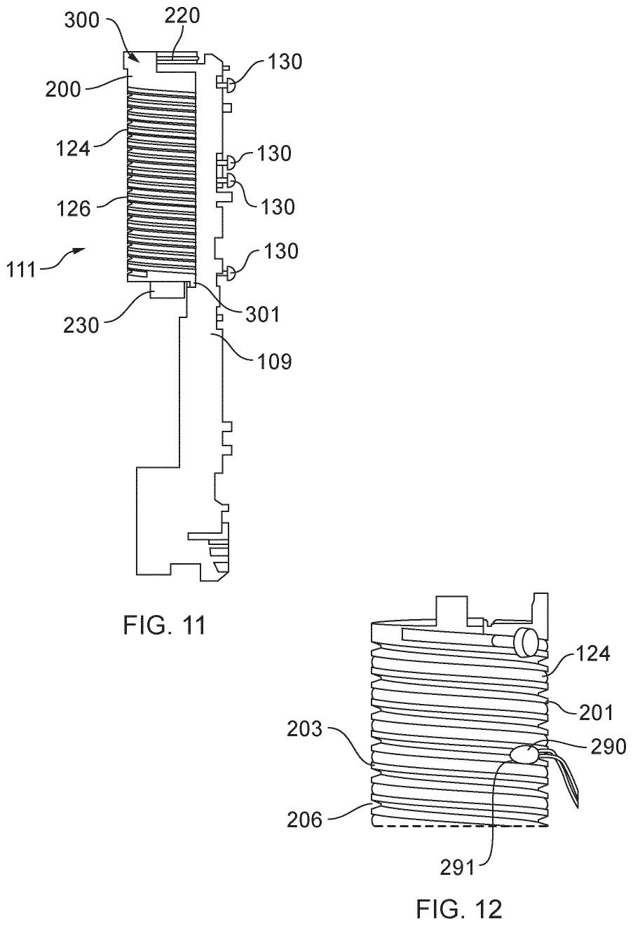

Referring to FIG. 11, the first end support 220 protrudes from the proximal end of the coil support 200. The second end support 230 protrudes from the distal end of the coil support 200. The first end support 220 is axially aligned. The second end support 230 is axially aligned. The aerosol generating assembly 111 is mounted to the (first) chassis 109. The aerosol generating assembly 111 is mounted at its proximal and distal ends. The aerosol generating assembly mount 113 of the chassis 109 holds the aerosol generating assembly 111.

The device 100 includes a locating arrangement. A first locating feature 300 of the locating arrangement locates the aerosol generating assembly 111 on the chassis 109 at the first, proximal, end. A second locating feature 301 of the locating arrangement locates the aerosol generating assembly 111 on the chassis 109 at the second, distal, end. The chassis 109 acts as a first chassis, with the coil support 200 acting as a second chassis. The second chassis 200 comprises the locating arrangement.

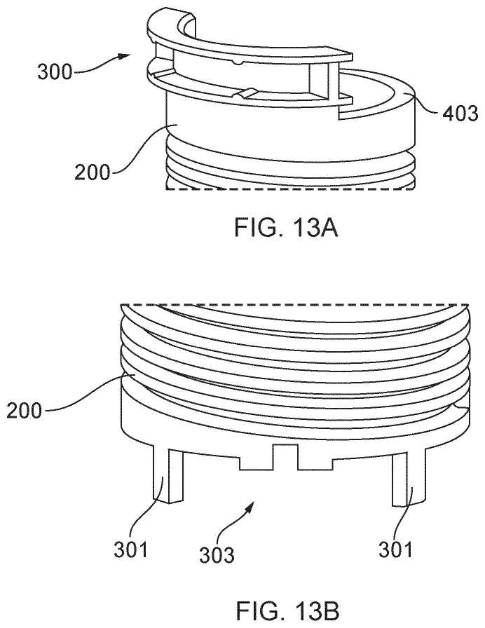

FIG. 13A show a close up view of the first, proximal end of the coil support 200 comprising the first locating feature 300, and FIG. 13B shows a close up view of the second, distal end of the coil support 200 comprising the second locating feature 301. The first locating feature 300 may locate the first, proximal end of the coil support (second chassis) 200, and thus the aerosol generating assembly 111, on the first chassis 109. The second locating feature 300 may locate the second, distal end of the coil support (second chassis) 200, and thus the aerosol generating assembly 111, on the first chassis 109.

The illustrated coil support 200 includes the first locating feature 300 at the first end of the coil support 200 and the second locating feature 301 at the second end of the coil support 200, but in other embodiments the first or second locating feature may be omitted. Furthermore, it would be possible for the first locating feature to be provided on the second, distal end of the coil support 200. Similarly, the second locating feature could be provided on the first, proximal end of the coil support 200. A locating feature may be provided at, or at least proximal to, one end of the second chassis 200.

As can be seen in FIG. 13B, the second chassis 200 may further comprise an orientation feature 303, which will be described below. In embodiments, the orientation feature 303 may be omitted.

As will become more clear below, the locating arrangement can help to position the aerosol generating assembly 111, and heater assembly 105, in a correct, e.g. unique, position and/or orientation relative to the first chassis 109, for example during and after assembly of the device 100.

For example, when the aerosol generating assembly 111 is located on the first chassis 109 by the locating arrangement of the second chassis 200, other components of the aerosol generating assembly 111 may be located in a desired position with respect to the chassis 109. For example, FIG. 11 shows the aerosol generating assembly 111 located on the first chassis 109 by the first locating feature 300 and the second locating feature 301. In this position, ends of the inductor coil 130 extending from the aerosol generating assembly 111 can be supported on the first chassis 109 and connected with the PCB 123.

Moreover, the locating arrangement may function as a alignment mechanism so as to reduce or prevent assembly errors. The provision of the locating arrangement can accordingly facilitate assembly ease and accuracy.

The locating arrangement can restrict or prevent movement of the aerosol generating assembly 111 relative to the first chassis 109. This may help to avoid the inductor coil experiencing a force which may undesirably stress or displace wires of the inductor coil, for example.

Furthermore, providing a locating feature as part of the second chassis 200 can allow the locating feature to be manufactured in a simple and straightforward manner. For example, the locating arrangement may be formed integrally with the coil support 200 in a single manufacturing step, for example by injection molding.

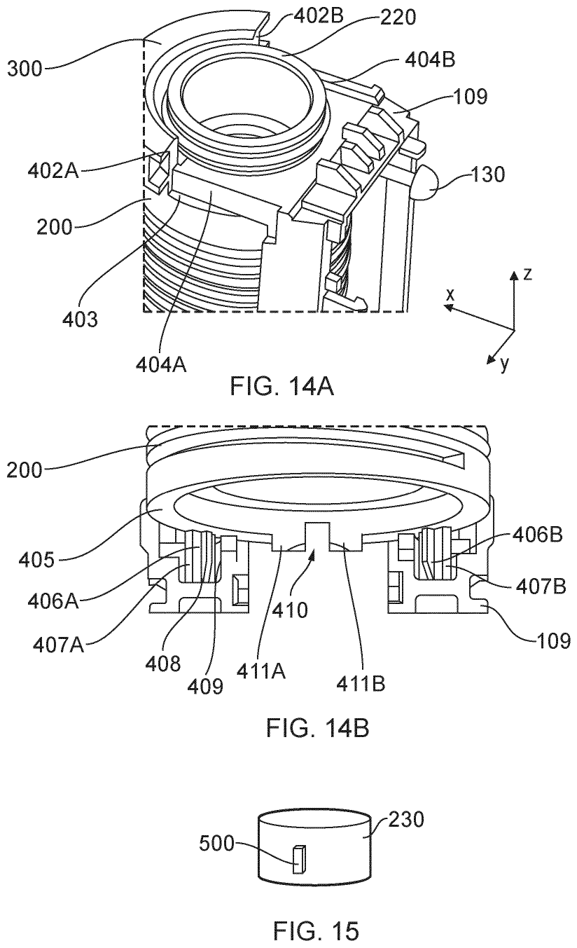

With reference to FIG. 14A, and as discussed above, the coil support 200 may be a substantially tubular member extending along and around the central longitudinal axis 101. The central longitudinal axis 101 may extend in a z-direction. FIG. 14A shows the first, proximal, end of the coil support 200 located on the chassis 109 by the first locating feature 300 of the coil support 200, and FIG. 14B shows the second, distal, end of the coil support 200 located on the chassis 109 by the second locating feature 301 of the coil support 200.

As can be seen in FIG. 14A, when the coil support 200 is mounted on the aerosol generating assembly mount 113 of the chassis 109, the aerosol generating assembly mount 113 may be positioned generally off-axis with respect to the central longitudinal axis 101 of the coil support 200, for example along an x-direction which is perpendicular to the z-direction. The first chassis 109 may comprise a first cooperating feature configured to cooperate with the first locating feature 300 to locate the first, proximal end of the aerosol generating assembly 111 on the chassis 109, and a second cooperating feature configured to cooperate with the second locating feature 301 to locate the second, distal end of the aerosol generating assembly 111 on the chassis 109.

With reference to FIGS. 10, 13A and 14A, the coil support 200 may comprise a partial tubular region 300 extending from a first, proximal axial end of a main tubular region of the coil support 200. The partial tubular region 300 may comprise a pair of surfaces 402A, 402B, which may extend axially (parallel to the longitudinal axis 101, in the z-direction). In this example, the surfaces 402A, 402B generally extend on the same y-z plane. Different planes would be possible. The surfaces 402A, 402B may be configured to abut corresponding cooperating surfaces of the chassis 109. The pair of abutting surfaces 402A, 402B may be spaced apart from each other in a direction perpendicular to the longitudinal axis 101, for example in a y-direction that is perpendicular to both the z and x directions.

A further abutting surface lying generally in a plane substantially perpendicular to the longitudinal axis 101 (e.g. x-y plane) may be defined by a first rim 403 formed at the first, proximal end of the main tubular region of the coil support 200.

As can best be seen in FIG. 14A, each abutting surface may be configured to abut a corresponding cooperating surface of the chassis 109 so as to locate first, proximal end of the coil support 200, and thus the aerosol generating assembly 111, on the chassis 109. The surfaces 402A, 402B may locate against cooperating surfaces in a radial direction. The first rim 403 may locate against a cooperating surface in an axial direction.

The first cooperating feature of the chassis 109 may comprise a pair of spaced apart parallel arms 404A, 404B extending substantially perpendicularly to the longitudinal axis 101, e.g. in the x-direction. An end of each arm 404A, 404B may comprise a cooperating surface in a plane substantially parallel to the longitudinal axis 101 (e.g. y-z plane) against which a respective one of the pair of abutting surfaces 402A, 402B abuts. A lateral surface of each arm may comprise a cooperating surface in a plane substantially perpendicular to the longitudinal axis 101 (e.g. x-y plane) against which the first rim 403 abuts. As shown in FIG. 14A, the pair of arms 404A, 404B may be further configured to grip the top end support 220 therebetween.

The surfaces are configured such that the coil support 200, and thus aerosol generating assembly 111, is located on the chassis 109 in a unique position and orientation. The abutment may be such that rotation of the second chassis 200 relative to the first chassis 109 is restricted. The abutment may be such that axial displacement of the second chassis 200 relative to the first chassis 109 is restricted.

As can best be seen in FIG. 14B, the coil support 200 may include a second rim 405 at the second, distal axial end. The second locating feature 301 may comprise one or more protrusions which may extend from the second rim 405 in the axial (z) direction (substantially parallel to the longitudinal axis 101). In the illustrated embodiment, the second locating feature 301 comprises a pair of protruding legs 406A, 406B which are spaced apart along the second rim 405. More than or less than two legs extending from the rim 405 would be possible.

Each leg 406A, 406B may be configured to engage a corresponding socket 407A, 407B in the aerosol generating assembly mount 113 of the chassis 109 so as to locate the second, proximal end of the coil support 200, and thus the aerosol generating assembly 111, on the chassis 109. The second cooperating feature of the chassis 109 may thus comprise a pair of sockets 407A, 407B in the aerosol generating assembly mount 113.

As can be seen in FIG. 14B, each socket 407A, 407B may be defined by a base surface 408 and one or more side wall surfaces 409 extending from the base surface 408. The engagement between a leg and corresponding socket may be such that a distal end of the leg abuts or is closely spaced from the base surface 408 of the corresponding socket, and such that one or more lateral edges of the leg abuts or is closely spaced from a corresponding side wall surface 409 of the corresponding socket.

The engagement is such that the coil support 200, and thus aerosol generating assembly 111, is located on the chassis 109 in a unique position and orientation.

As shown in FIG. 14A, when the coil support 200 is located on the first chassis 109 by the first and second locating features, an end of the inductor coil 130 is positioned in a desired position relative to the first chassis 109. In this position, the inductor coil end 130 can, for example, be connected with the PCB 123. Similarly, other ends (not shown) of the inductor coil may be positioned in a desired position relative to the first chassis 109. This may enable the inductor coil end(s) 130 to be soldered precisely to the PCB 123.

As mentioned above, the second chassis (coil support) 200 may further comprise an orientation feature 303. Referring to FIG. 14B, the orientation feature 303 may comprise a slot 410 extending in the axial direction. It would be possible for a slot to extend in another direction. The slot 410 may be defined by a recess extending into the second rim 405 in the axial direction and/or between a pair of spaced apart legs 411A, 411B extending from the second rim 405 in the axial direction. The slot 410 may be positioned in between the pair of protruding legs 406A, 407A discussed above. The slot 410 extends through the entire radial thickness of the coil holder 200. It would be possible for the slot to extend only partially through the radial thickness of the coil holder 200.

Referring to FIG. 15, the slot may be configured to receive and engage a stop in the form of a protrusion 500 provided on the second end support 230 so as to restrict or prevent movement and/or rotation of the second end support 230 relative to the coil support 200. In particular, the engagement may be such that rotation of the second end support 230 about the longitudinal axis 101 is restricted or prevented. In embodiments, a slot may be provided on the second end support 230, and a corresponding protrusion may be provided on the coil support 200.

In a similar manner to as discussed above, the provision of an orientation feature can facilitate assembly ease and accuracy. Moreover, (once assembled) the orientation feature can restrict or prevent undesired movement of the second end support 230 relative to the coil support 200.

The provision of the orientation feature can allow precise alignment between the second end support 230 relative to the coil support 200, which may facilitate the provision of a sealed air path through the second end support 230 and the heater assembly 105.

The at least one locating feature and/or the orientation feature may be formed integrally with the coil support 200, for example by injection molding. The at least one locating feature and/or the orientation feature may thus be formed from the same material as the coil support 200.

In embodiments, the at least one locating feature and/or the orientation feature is formed from a non-metallic material to assist with limiting interference with magnetic induction. In this particular example, the at least one locating feature and/or the orientation feature is constructed from polyether ether ketone (PEEK). Other suitable materials are possible. Such materials can ensure suitable rigidity/solidity when the susceptor is heated. The at least one locating feature and/or the orientation feature may be constructed from an insulating material, such as plastic for example.

Similarly, the second end support 230 comprising the protrusion 500 may be formed integrally, for example by injection molding, and from the same material, such as PEEK.

In the above examples, the susceptor 132 has a thickness 154 of about 0.08 mm. The thickness of the susceptor 132 is the average distance between the inner surface of the susceptor 132 and the outer surface of the susceptor 132, measured in a direction perpendicular to the axis 158.

In an example, the susceptor 132 has a length of between about 30 mm and about 50 mm, or between about 30 mm and about 35 mm. In this particular example, the susceptor 132 has a length of about 34.8 mm and can receive an article 110 comprising aerosol generating material, where the aerosol generating material has a length of about 42 mm. The length of the aerosol generating material and susceptor 132 is measured in a direction parallel to the axis 101.

The outer cover 102 provides protection to the internal components of the device, and is generally in contact with a user's hand when the device is in use. The outer cover 102 comprises an inner surface and an outer surface. The inner surface is arranged further away from the susceptor 132 than the outer surface. To ensure that the device 100 is not too hot to touch, an air gap may be provided between the inner surface of the outer cover 102 and the aerosol generating assembly. In this example, the inner surface of the outer cover 102 is positioned away from an outer surface of the susceptor 132 by a distance of between about 4 mm and about 10 mm. In this particular example, the distance is about 5.3 mm.

In some examples the inductor coil itself may heat up as it is used to induce a magnetic field, for example from resistive heating due to the current passing through it to induce the magnetic field. Providing an insulating layer between the inductor coil and outer cover helps ensure that the heated inductor coil is insulated from the outer cover. The ferrite shielding helps insulate the outer cover. It has been found that when the ferrite shielding is in contact with, and at least partially surrounds the one or more inductor coils, the surface temperature of the outer cover can be reduced by about 3° C.

The inner surface of the outer cover may be positioned away from the outer surface of the insulating member by a distance of between about 2 mm and about 3 mm. It has been found that a separation distance of this size provides enough insulation to ensure that the outer cover does not get too hot. Air may be located between the outer surface of the insulating member and the outer cover.

The inner surface of the outer cover may be positioned away from an outer surface of the inductor coil by a distance of between about 0.2 mm and about 1 mm.

The inner surface of the inductor coil may be positioned away from the outer surface of the susceptor by a distance of between about 3 mm and about 4 mm. In this particular example, the distance is about 3.2 mm.

The outer cover may comprise aluminum.

The outer cover may have a thermal conductivity of between about 200 W/mK and about 220 W/mK. For example, aluminum has a thermal conductivity of around 209 W/mK.

The outer cover may have a thickness of between about 0.75 mm and about 2 mm. The outer cover may act as an insulating barrier.

Although each of the susceptor 132, barrier member 250, and coil support 200 have a circular shaped cross section, their cross sections may have any other shape, and in some examples may be different to each other.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure.

1. An aerosol provision device, comprising:
a first chassis; and
an aerosol generating assembly, the aerosol generating assembly comprising:
a second chassis;
a heater assembly configured to receive aerosol generating material, wherein the heater assembly comprises a susceptor which is heatable by penetration with a varying magnetic field;
the second chassis extending around the susceptor; and
an inductor coil extending around the second chassis, wherein the inductor coil is configured to generate the varying magnetic field;
wherein the second chassis comprises a locating arrangement configured to locate the aerosol generating assembly on the first chassis.

2. The aerosol provision device of claim 1, wherein the second chassis is configured to enclose the heater assembly.

3. The aerosol provision device of claim 1, wherein the second chassis is configured to locate the heater assembly on the first chassis.

4. The aerosol provision device of claim 1, wherein the second chassis comprises a coil support configured to support the inductor coil.

5. The aerosol provision device of claim 1, wherein the locating arrangement comprises a locating feature at least proximal to one end of the second chassis.

6. The aerosol provision device of claim 5, wherein the aerosol provision device comprises an end support at one end of the heater assembly, wherein the end support is mounted with the second chassis.

7. The aerosol provision device of claim 6, wherein the locating feature locates the second chassis with the first chassis and the end support supports the aerosol provision device on the first chassis.

8. The aerosol provision device of claim 5, wherein the locating feature comprises an abutment, the first chassis comprises a cooperating surface, and the abutment abuts the cooperating surface to locate the aerosol generating assembly on the first chassis.

9. The aerosol provision device of claim 8, wherein the second chassis has a longitudinal axis and the abutment locates against the cooperating surface in a radial direction.

10. The aerosol provision device of claim 8, wherein the locating feature restricts rotation of the second chassis relative to the first chassis.

11. The aerosol provision device of claim 5, wherein the locating feature comprises at least one protrusion, the first chassis comprises at least one socket, and the at least one protrusion is received by the at least one socket to locate the aerosol generating assembly on the first chassis.

12. The aerosol provision device of claim 11, wherein the second chassis has a longitudinal axis, and the at least one protrusion extends in the axial direction.

13. (canceled)

14. The aerosol provision device of claim 5, wherein the locating feature is a first locating feature at least proximal to a first end of the second chassis and the second chassis comprises a second locating feature at least proximal to a second end of the second chassis.

15-16. (canceled)

17. The aerosol provision device of claim 1, comprising an end support at one end of the second chassis, and an air passage passing through the heater assembly and the end support, wherein the second chassis comprises an orientation feature configured to restrict rotation of the end support relative to the second chassis.

18. An aerosol provision device, comprising:
a receptacle configured to receive aerosol generating material, wherein the receptacle comprises a susceptor which is heatable by penetration with a varying magnetic field;
a coil support extending around the susceptor;
an inductor coil extending around the coil support, wherein the inductor coil is configured to generate the varying magnetic field;
an end support at one end of the coil support; and
an air passage passing through the receptacle and the end support;
wherein the coil support comprises an orientation feature configured to restrict rotation of the end support relative to the coil support.

19. The aerosol provision device of claim 17, wherein the end support comprises a stop configured to cooperate with the orientation feature so as to restrict rotation of the end support relative to the coil support.

20. The aerosol provision device of claim 19, wherein the orientation feature comprises a slot, and the stop comprises a protrusion engaging the slot so as to restrict rotation of the end support relative to the coil support.

21. An inductor coil support for an aerosol provision device comprising a chassis, the inductor coil support comprising at least one locating feature configured to locate the inductor coil support on the chassis.

22. An aerosol provision system comprising:
the aerosol provision device of claim 1; and
an article comprising aerosol generating material, wherein the article is dimensioned to be at least partially received within the heater assembly.

23. The system of claim 22, wherein the article is dimensioned to be at least partially received within the susceptor.
